(19) United States
(12) Patent Application Publication
(10) Pub. No.: US 2015/0105043 A1
(43) Pub. Date: Apr. 16, 2015

(54) Pro-Active Mobile Network Data Usage Alert System

(71) Applicant: Opera Software Ireland Limited, Dublin (IE)

(72) Inventors: Naveen Puvvula, Santa Clara, CA (US); Nitin Bhandari, Pleasanton, CA (US)

(21) Appl. No.: 14/515,391

(22) Filed: Oct. 15, 2014

Related U.S. Application Data
(60) Provisional application No. 61/891,368, filed on Oct. 15, 2013.

(51) Int. Cl. H04M 15/00; H04W 28/06; H04W 4/26

(52) U.S. Cl. CPC H04M 15/844; H04W 4/26; H04W 28/06
USPC 455/405

(57) ABSTRACT

A flow analyzer analyzes data consumption of flows associated with a user device of a user. The flow analyzer determines, for a given flow associated with the user device, whether to generate a notification alerting the user about data consumption on the network associated with the given flow. For example, if the given flow contains a large object requiring an inordinate amount of data consumption or contains many smaller objects that in the aggregate require an inordinate amount of data consumption to provide the flow to the user device, the flow analyzer may generate a notification including information alerting the user to the size of the flow or object. Thus, the user may elect whether to continue a flow that may significantly impact their data allowance prior to incurring the costs.

### CROSS REFERENCE TO RELATED APPLICATIONS

This application claims the benefit of U.S. Provisional Application No. 61/891,368 filed on Oct. 15, 2013, which is incorporated by reference herein in its entirety.

### BACKGROUND

1. Field of Art

The disclosure generally relates to improving user experience on a network, and more specifically, to monitoring data consumption of the user on the network to automatically generate notifications alerting the user of excessive data consumption.

2. Description of the Related Art

Mobile devices, such as smart phones and tablets, have become prevalent in recent years. Given the fast advance in mobile computing power and far-reaching wireless Internet access, more and more users consume large objects such as videos, high-resolution images, audio, applications, and other content on their mobile devices. Wireless Internet data is oftentimes expensive and the more a user consumes the more costs can add up for the user.

Many applications exist to show the user the amount of data consumed after an event. However, excessive costs might have already added up for the user. Additionally, the monitoring performed by the application may not take account of data being consumed in ongoing sessions.

Difficulties in monitoring data consumption also arise from variation in large object parameters impacting object size and thus total data usage associated with consuming the large object. For example, quality or compression (high vs low), duration (long vs short), bitrate (high vs low), and others vary heavily across different types of large objects and even for same types of objects. Considering large video objects, for example, there is no specific universal standard and online content providers simply want to push the best quality video to users. The content providers may also be unaware of the type of access point (e.g., a wireless tower or free hotspot) utilized by the user at any given time and thus unable to intelligently adjust their consumption.

Wireless carriers want to enhance user experience by keeping the user informed of excess data consumption, however the wireless carrier might not have the exact information in time to inform the user. Additionally, while mobile service providers use inline network appliances that monitor subscriber traffic, these devices are tasked with high priority operations such as making estimates of network throughput to maintain the health of the network.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1A illustrates a block diagram of an example communications environment for notifying a user about their data consumption on a network with an inline appliance, according to one embodiment.

FIG. 1B illustrates a block diagram of an example communications environment for notifying a user about their data consumption on a network at a user device, according to one embodiment.

FIG. 2A illustrates a block diagram of an example communications environment for notifying a user about their data consumption on a network with a network controller, according to one embodiment.

FIG. 2B illustrates a block diagram of an example communications environment for notifying a user about their data consumption on a network with a network controller, according to one embodiment.

FIG. 3 illustrates an example architecture of a computing device for notifying a user about their data consumption on a network, according to one embodiment.

FIG. 4 illustrates a block diagram of a flow analyzer for notifying a user about their data consumption on a network, according to one embodiment.

FIG. 5 illustrates a block diagram of a flow interceptor for selecting flows to analyze for notifying a user about their data consumption on a network, according to one embodiment.

FIGS. 6A, 6B, and 6C illustrate example event traces for notifying a user about their data consumption on a network, according to various embodiments.

FIG. 7 illustrates an example user interaction associated with consuming data on a network, according to one embodiment.

FIGS. 8A and 8B illustrate example user interfaces on a user device for notifying a user about their data consumption on a network, according to various embodiments.

FIG. 9 illustrates an example web page displayed on a user device for notifying a user about their data consumption on a network, according to one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

A system, method, and computer readable storage medium storing computer program instructions for selectively notifying a user about their data consumption on a network are disclosed. The system comprises a flow analyzer that analyzes data consumption of flows associated with a user device of the user. The flow analyzer determines, for a given flow associated with the user device, whether to generate a notification alerting the user about data consumption on the network associated with the given flow. For example, if the given flow contains a large object requiring an inordinate amount of data consumption to provide the large object to the user device, the flow analyzer may generate a notification including information alerting the user to the size of flow (and/or the large object individually). In another example, the given flow may contain many smaller objects that in the aggregate require an inordinate amount of data consumption to provide the flow to the user device, the flow analyzer may generate a notification including information alerting the user to the size of the flow. Hence, the flow analyzer may determine whether to generate a notification based on the size of content of a flow in the aggregate and/or individual large objects within the flow. In the case of individual large object(s) within a flow, the flow analyzer may generate a notification for a large object(s) individually and continue other content of the flow (e.g., small objects therein) to the user device.

The flow analyzer may also determine whether to generate the notification based on a subscriber account of the user with a service provider providing the user device with access to the network. The subscriber account permits the user device (or devices) of the user to access the network through the service provider and may include consumption properties describing allowed period data consumption (e.g., over a billing cycle, week, or day) and/or limits (or privileges) thereof, and/or data consumption limits (or privileges) for receiving a large object or flow for one or more individual the user devices and/or for the subscriber account overall. The flow analyzer may consult the consumption properties of the subscriber account associated with the user device to determine whether a flow would exceed one or more of the consumption properties. In turn, the flow analyzer may generate a notification including information alerting the user to the size of a flow (and/or the large object individually) and describing the one or more of the consumption properties that delivery of the flow (and/or the large object individually) would exceed.

The flow analyzer may determine one or more of the consumption properties indicated above, and may further determine other or additional consumption properties such as a notification threshold (e.g., 80% or 90%) of a consumption property for notifying a user during a period when the user approaches exceeding the consumption property. For example, the flow analyzer may notify the user of large objects in a flow after reaching a threshold (e.g., 80% or 90%) of a consumption property. Accordingly, the notification for the large object may include information indicating the size and type of the large object (e.g., this video is 100 megabytes) and a status of the user's data consumption associated with the consumption property (e.g., 90% of a monthly 2 GB used, watching this video will consume an additional 5% or 90% of a monthly 2 GB used, 5% will remain after watching the video, and similar). Notifications for a flow may include similar information, for example, the requested webpage is 100 megabytes, 90% of a monthly 2 GB used, loading this webpage will consume an additional 5% or 90% of a monthly 2 GB used, 5% will remain after loading the webpage, and similar.

In some embodiments, the user may respond to the notification by indicating that they would like to continue a flow or receive a large object contained in a flow on the user device. Accordingly, the flow analyzer may continue a flow to allow delivery of flow content subsequent to a notification based on a notification response received from the user device. Alternatively, a notification response may indicate that the user elected not to receive flow content to which the user was notified of on the user device, in which case the flow content pertaining to the notification is not provided to the user device.

### Pro-Active Alerts

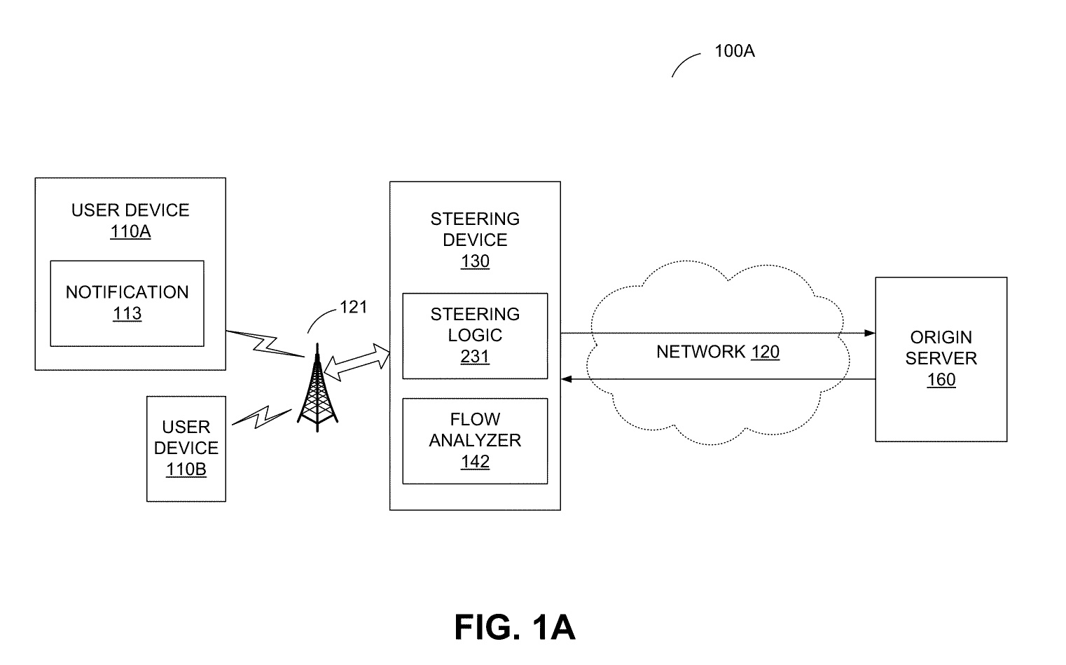

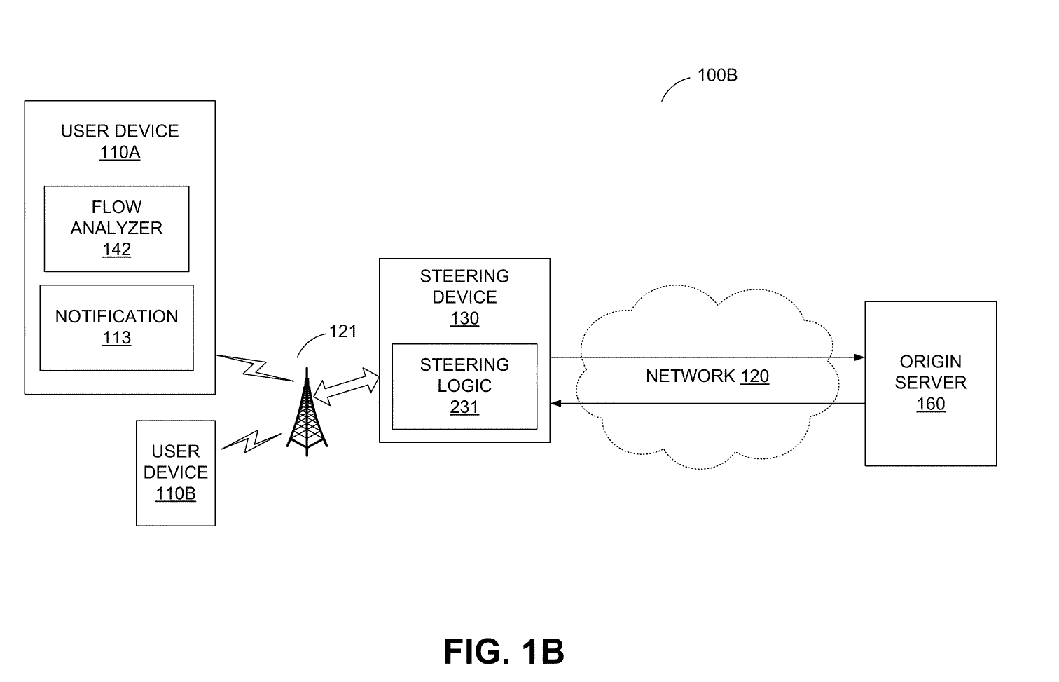

FIG. 1A illustrates a block diagram of an example communications environment 100A for notifying a user about their data consumption on a network with an inline appliance, according to one embodiment. The environment 100A comprises user devices 110A, 110B, an origin server 160, a steering device 130, and a network 120.

The network 120 is a communication network that transmits data between the user devices 110, the steering device 130 and the origin server 160. In one embodiment the network 120 includes wireless network and the Internet. The network 120 can also utilize dedicated or private communications links that are not necessarily part of the Internet. In one embodiment, the network 120 uses standard communications technologies and/or protocols. Thus, the network 120 can include links using technologies such as Ethernet, 802.11, integrated services digital network (ISDN), digital subscriber line (DSL), asynchronous transfer mode (ATM), etc. Similarly, the networking protocols used on the network 114 can include the transmission control protocol/Internet protocol (TCP/IP), the hypertext transport protocol (HTTP), the simple mail transfer protocol (SMTP), the file transfer protocol (FTP), etc. The data exchanged over the network 120 can be represented using technologies and/or formats including the hypertext markup language (HTML), the extensible markup language (XML), etc. In addition, all or some of links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above. For example, wireless access points 121 such as cellular towers may be utilized by the user device 121 to transmit and receive data over the network through the steering appliance 130. A service provider may implement and manage the wireless access points 121 to provide authorized user devices 110 or users of the user devices 110 wireless access to the network.

In one embodiment, the user devices 110 are computing devices with network capabilities for consuming online content. Oftentimes, for example, the user devices 110 are wireless enabled mobile computing devices configured to access the network 120 from wireless access points 121 and may include applications for accessing online data. Example applications for accessing online data include applications such as a web browser and media players that send/receive network data and present received data to the user. The user devices 110 as mobile computing devices may include laptops, netbooks, tablets, smart telephones, or personal digital assistants (PDAs). While only two user devices 110A and 110B are illustrated in FIG. 1A, the environment 100A may include thousands or millions of such devices. The applications such as a web browser may be software applications running on mobile devices 110 for consuming content on the origin server 160. For example, the user device 110A may retrieve web content from the origin server 160 for presentation on a display coupled to the mobile device. Web content accessed by the user devices 110 may include text, images, audio and video content. The multimedia content can be played back by the browsers, for example, HTML5 compatible browsers, plug-in or a standalone media player. The browsers can also invoke the media players or plug-ins available on the user devices 110 and passes images, audio and/or video to the media player or plug-in for playback. The applications may also retrieve other content such as new applications (e.g., as a package) for installation to the user devices 110 or otherwise retrieve content for storage and access on the user devices 110.

The steering device 130 may be a load balancer or a router located between the user device 110 and the network 120. The steering device 130 provides the user device 110 with access to the network and thus, provides the gateway through which the user device traffic flows onto the network 120 and vice versa. In one embodiment, the steering device 130 includes steering logic 231 for routing traffic between a particular user device 110A and a particular origin server 160. In other words, the steering logic 231 directs traffic, such as a request for content, from the user device 110A to the appropriate destination, e.g., origin server 160, and directs traffic from the origin server 160, e.g., the content, to the appropriate destination, e.g., the user device 110A having requested the content. The traffic associated with the retrieval and delivery (consumption) of content between the user device 110A and origin service 160 is known as a flow. Multiple flows may exist between a given user device 110A and the origin server 160, or with multiple origin servers (not shown).

In one embodiment, the steering device 130 includes a flow analyzer 142 for categorizing traffic routed through the steering device 130 to identify flows of interest for further inspection by the flow analyzer 142. For example, the flow analyzer 142 may categorize a flow based on the size of one or more objects associated with the flow. Flows categorized as providing small objects such as text, compressed or small amounts of media to the user devices 110 may continue through the steering device 130 absent additional processing. Small object flows require the delivery of a minimal amount of data (e.g., <1 MB-5 MB) to the user devices 110 and thus have a minimal impact on their data usage. On the other hand, flows containing a large object or many media objects may require the delivery of a significant amount of data (e.g., >1 MB-5 MB) to the user devices 110 and thus may have a medium to large impact on their data usage. Flows categorized as providing large objects such as high-definition media and lengthy media or large amounts of media to the user devices 110 may be further inspected to determine their size and whether delivery of the flow or large object therein would adversely impact a user of a user device, e.g., the user of user device 110A. If the flow analyzer 142 determines that a given flow would adversely impact the user of user device 110A, the flow analyzer 142 generates a notification 113 for display on the user device 110A to alert the user prior to delivery of flow content. Thus, for example, the user may choose to continue a flow to receive a large object and thereby incur data consumption associated with providing the object to their user device 110A or choose not to continue a flow so as not incur data consumption associated with providing the large object to their user device 110A.

In analyzing a given flow associated with a user device 110A identified for further inspection, the flow analyzer 142 may consult data usage information specific to the user and/or user device and/or general to user devices accessing the network for generating a notification. Example information can include network traffic data, subscriber account information, and/or other determined information for the user and/or user device. Example historical network traffic data may include information about flows associated with the user and/or user device 110A such as tracked period data consumption (e.g., over a current billing cycle, week, or day). Example subscriber account information may include consumption properties describing allowed period data consumption (e.g., over a billing cycle, week, or day) and/or limits (or privileges) thereof, and/or data consumption limits (or privileges) for receiving a large object or flow for one or more individual the user devices and/or for the subscriber account overall. Additional determined information stored in the subscriber log may include consumption properties determined by the flow analyzer 142 for the user and/or user device 110A such as a threshold (e.g., 80% or 90%) of a consumption property for notifying the during a period when the user approaches exceeding the consumption property.

As described above, the flow analyzer 142 may generate a notification 113 for display on the user device 110A. Generally, the notification 113 alerts the user of the user device 110A of flows for providing large objects or flows for many objects that, if continued, could be detrimental to the user, e.g., due to the user and/or user device 110A exceeding (or approaching exceeding) allowed period data consumption and/or consumption limits for large objects or flows. A notification 113 may include information describing the detrimental effects of continuing the flow and a status of the user's tracked data consumption associated with the consumption property. The notification process and type of notification may differ depending on the embodiment, and while various examples thereof are described herein, they are not exhaustive. For example, other types of notifications may indicate to the user that a large object or flow exceeds a limit, and thus the delivery of flow content will not be continued, or similar when the user has already exceed a period data consumption limit. Additional types of notifications may indicate user specified privileges for the user device 110A (e.g., parental controls) or service provider specified privileges for the user device 110A and/or subscriber account that have been revoked (e.g., unpaid bill, level of service, and the like) to prevent continuation of flow content to the user device.

### Additional Example Communication Environments for Pro-Active Alerts

FIG. 1B illustrates a block diagram of an example communications environment 100B for notifying a user about their data consumption on a network at a user device 110A, according to one embodiment. The environment 100B comprises user devices 110A, 110B, an origin server 160, a steering device 130, and a network 120.

In contrast to the environment shown in FIG. 1A, user device 110A includes the flow analyzer 142 instead of the steering device 130. Thus, a user device may execute the flow analyzer 142 to generate notifications of user data consumption locally on the user device 110A in instances where the network does not provide a notification service. The flow analyzer 142 may be included as a component or module of another application on the user device 110A, such as a web browser or media player, that users typically utilize when consuming large amounts of data. The flow analyzer 142 may also be a standalone application installed to the user device 110A or a service of an operating system of the user device 110A. In some embodiments, when executed, the flow analyzer 142 runs in the background to monitor network data consumption of applications running on the user device 110A when the user device connected to a wireless access point 121.

As described above, the steering device 130 includes steering logic 231 for routing traffic between a particular user device 110A and a particular origin server 160. In other words, the steering logic 231 directs traffic, such as a request for content, from the user device 110A to the appropriate destination, e.g., origin server 160, and directs traffic from the origin server 160, e.g., the content, to the appropriate destination, e.g., the user device 110A having requested the content. The traffic associated with the retrieval and delivery (consumption) of content between the user device 110A and origin service 160 is known as a flow. Multiple flows may exist between a given user device 110A and the origin server 160, or with multiple origin servers (not shown).

The flow analyzer 142 on the user device 110A categorizes network traffic flowing to/from the user device to identify flows of interest for further inspection by the flow analyzer 142. For example, the flow analyzer 142 may categorize a flow based on the size of one or more objects associated with the flow. Flows categorized as providing small objects such as text, compressed or small amounts of media to the user devices 110 may be allowed to continue absent additional processing. Small object flows require the delivery of a minimal amount of data (e.g., <1 MB-5 MB) to the user devices 110 and thus have a minimal impact on user data usage. On the other hand, flows containing a large object or many media objects may require the delivery of a significant amount of data (e.g., >1 MB-5 MB) to the user devices 110 and thus may have a medium to large impact on their data usage. Flows categorized as providing large objects such as high-definition media and lengthy media or large amounts of media to the user devices 110 may be further inspected to determine their size and whether continuing delivery of the flow or large object therein would adversely impact the user of the user device 110A. If the flow analyzer 142 determines that a given flow would adversely impact the user of user device 110A, the flow analyzer 142 generates a notification 113 for display on the user device 110A to alert the user prior to continuing delivery of flow content. Thus, for example, the user may choose to continue a flow to receive a large object and thereby incur data consumption associated with providing the object to their user device 110A or choose not to continue a flow so as not incur data consumption associated with providing the large object to their user device 110A.

In embodiments where the flow analyzer 142 is implemented at the user device 110A, some initial amount of data (e.g., response and/or packets) for a large object or large flow may be received at the user device 110A in order for the flow analyzer 142 perform the analysis. Accordingly, the flow analyzer 142 may perform operations to prevent receipt of additional traffic associated with the flow, e.g., by pausing a flow (wait to timeout), not confirming receipt of a packet, not generating a request for data, etc.

In analyzing a given flow associated with a user device 110A identified for further inspection, the flow analyzer 142 may consult information specific to the user and/or user device and/or general to user devices accessing the network for generating a notification. In some embodiments, the user may provide some or all of the information to the flow analyzer 142. For example, when the flow analyzer 142 is installed or first launched, the flow analyzer 142 may query the user for subscriber account information directly or to provide login credential for their subscriber account such that the flow analyzer 142 may access subscriber account information from the corresponding carrier or service provider.

As described above, the flow analyzer 142 may generate a notification 113 for display on the user device 110A. Generally, the notification 113 alerts the user of the user device 110A of flows for providing large objects or flows for many objects that, if continued, could be detrimental to the user, e.g., due to the user and/or user device 110A exceeding (or approaching exceeding) allowed period data consumption and/or consumption limits for large objects or flows. A notification 113 may include information describing the detrimental effects of continuing the flow and a status of the user's tracked data consumption associated with the consumption property. The notification process and type of notification may differ depending on the embodiment, and while various examples thereof are described herein, they are not exhaustive.

In instances where the flow analyzer 142 monitors data consumption of a variety of applications on the user device, the flow analyzer 142 may generate the notification via a notification interface on the user device 110. For example, the flow analyzer 142 may provide the notification to the notification interface which may display the notification on the user device 110A as an overlay, banner, or indicate presence of the new notification in a status bar within the interface of the user device 110A. In instances where the flow analyzer 142 is incorporated within another application such as a browser, the flow analyzer and/or browser may display the notification directly in the interface of the application a similar fashion.

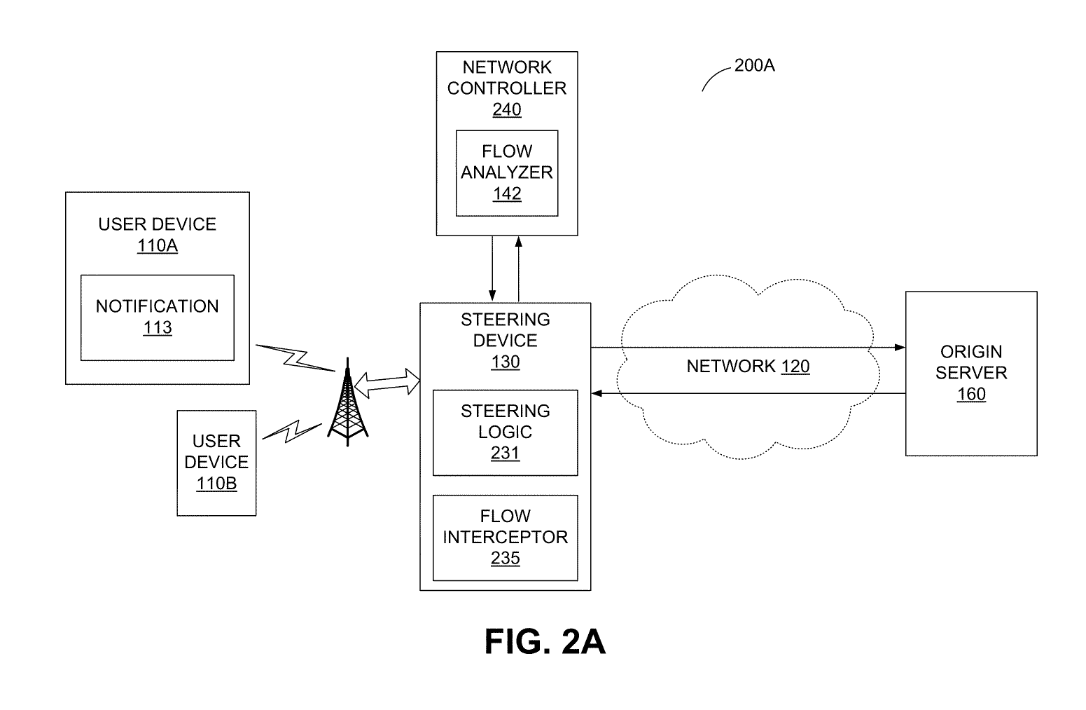

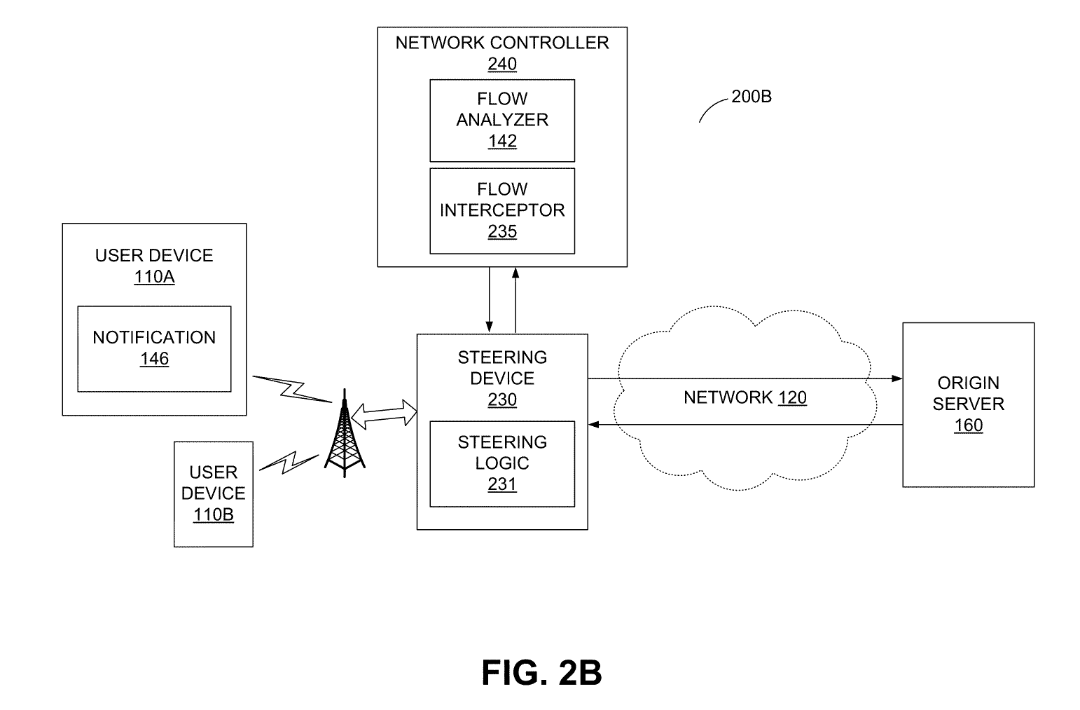

FIG. 2A illustrates a block diagram of an example communications environment 200A for notifying a user about their data consumption on a network 120 with a network controller 240, according to one embodiment. The environment 200A comprises user devices 110A, 110B, an origin server 160, a steering device 130, and a network 120. The network 120 is a communication network that transmits data between the user devices 110, the steering device 130, and the origin server 160. In some embodiments, the network controller 240 is coupled to the network 120 to transmit and receive data from the steering device 130. In other embodiments, the network controller 240 and the steering device 130 are coupled through an internal network, bus or other interface.

In contrast to the environment shown in FIG. 1A, a network controller 240 includes the flow analyzer 142 instead of the steering device 130, while the steering device 130 includes a flow interceptor 235. The flow interceptor 235 performs the categorization of flows to identify flows through the steering device 130 that are of interest for further inspection, such as those for providing large objects and/or many objects to the user devices 110. In turn, the steering logic 231 routes traffic associated with flows categorized for further inspection through the network controller 240, thus offloading the detailed analyses and notification operations performed by the flow analyzer 142 to the network controller 240. In other embodiments, the flow interceptor 235 may route the flows identified for further inspection through the network controller 240.

The offloading of analysis and notification generation to the network controller 240 frees steering device 130 bandwidth and memory to improve efficiency. Furthermore, when implementation of steering devices are localized, such as a per cellular tower, or per region basis, it can be difficult (and consume valuable bandwidth) to push all relevant subscriber data for generating notifications to a particular steering device 130 for the flows it currently handles. A more centralized network controller 240 that performs selective processing for a subset of the flows can increase efficiency in such network configurations as well. In other words, the network controller 140 is an “out-of-band” computer server interfaced with the in-line steering device 130 to further inspect the user flows identified as of interest, such as flows categorized as providing large objects by the flow interceptor 235.

When a flow is routed through the network controller 240, the flow analyzer 142 determines whether the flow should be continued or whether to generate a notification 113 for display on the corresponding user device (e.g., user device 110A). If the flow should be continued, the network controller 240 hands the flow back to the steering device 130. For example, the flow analyzer 142 may provide received flow data back to the steering device 130 and/or flow interceptor 235 to allow traffic associated with the flow to proceed to/from the corresponding user device 110A and the origin server 160. Further, the flow analyzer 142 may provide a category for the flow to the flow interceptor 235 and/or steering device 130 such that traffic associated with the flow ceases to pass through the network controller 240.

If the flow analyzer 142 determines that a notification 113 for content of the flow should be generated for display on the user device 110A, the flow analyzer 142 generates the notification 113 which is transmitted to the user device 110A for display prior to delivery of the flow content to which the user was notified on the user device 110A. Thus, the user may respond to the notification to choose to continue the flow to receive the content and thereby incur data consumption associated with providing the content to their user device 110A or choose not to continue a flow so as not incur data consumption associated with providing the content to their user device 110A. If the user indicates they desire to continue the flow to receive the notified flow content, the network controller 240 hands the flow back to the steering device 130. In one embodiment, the network controller 240 hands the flow back to the steering device 130 as described above. Alternatively, if the user elects to not continue the flow and thus not receive the notified flow content, the network controller 240 may instruct the steering device 130 and/or flow interceptor 235 to terminate delivery of the notified flow content.

FIG. 2B illustrates a block diagram of an example communications environment 200B for notifying a user about their data consumption on a network 120 with a network controller 240, according to one embodiment. The environment 200B comprises user devices 110A, 110B, an origin server 160, a steering device 130, and a network 120. The network 120 is a communication network that transmits data between the user devices 110, the steering device 130, and the origin server 160. In some embodiments, the network controller 240 is coupled to the network 120 to transmit and receive data from the steering device 130. In other embodiments, the network controller 240 and the steering device 130 are coupled through an internal network, bus or other interface.

In contrast to the environment shown in FIG. 2A, a network controller 240 includes the flow interceptor 235 instead of the steering device 130. This configuration further offloads flow processing requirements of the steering device 130 as the categorizing flows through the steering device 130 is handled at the network controller 240. In an embodiment, the flow interceptor 235 includes an interface to obtain or otherwise receive from parameters for flows through the steering device 130. The flow interceptor 235 performs the categorization of flows based on the flow parameters to identify flows through the steering device 130 that are of interest for further inspection at the network controller 240, such as those providing a large object or many objects to the user devices 110. In an example, if a flow is categorized for further inspection, the flow interceptor 235 instructs the steering device 130 to route traffic associated with the flow through the network controller 240. In one embodiment, the flow interceptor 235 instructs the steering device 130 by monitoring the traffic flowing through the steering device 130 to identify the individual traffic data associated with the flow and selectively instruct the steering device 130 to route the identified traffic data to the network controller 240. In another embodiment, the flow interceptor 235 instructs the steering device 130 by modifying the steering logic 231 to route the traffic associated with the flow through the network controller 240.

When a flow is routed through the network controller 240, the flow analyzer 142 determines whether the flow should be continued or whether to generate a notification 113 for display on the corresponding user device (e.g., user device 110A). If the flow should be continued, the network controller 240 hands the flow back to the steering device 130. For example, the flow analyzer 142 may provide received flow data back to the steering device 130 to allow traffic associated with the flow to proceed to/from the corresponding user device 110A and the origin server 160. Further, the flow analyzer 142 may provide a category for the flow to the flow interceptor 235. In turn, the flow interceptor 235 causes the steering device 130 to cease routing traffic associated with the flow through the network controller 240. In one embodiment, the flow interceptor 235 stores the categorization to cease selectively instructing the steering device 130 to route identified traffic data associated with the flow to the network controller 240. In another example, the flow interceptor 235 modifies the steering logic 231 to cease routing of the traffic associated with the flow through the network controller 240.

If the flow analyzer 142 determines that a notification 113 for content of the flow should be generated for display on the user device 110A, the flow analyzer 142 generates the notification 113 which is transmitted to the user device 110A for display prior to delivery of the flow content to which the user was notified on the user device 110A. Thus, the user may choose to continue the flow to receive the content and thereby incur data consumption associated with providing the content to their user device 110A or choose not to continue a flow so as not incur data consumption associated with providing the content to their user device 110A. If the user indicates they desire to continue the flow, the network controller 240 hands the flow back to the steering device 130. In one embodiment, the network controller 240 hands the flow back to the steering device 130 as described above. Alternatively, if the user elects to not continue the flow, the network controller 240 may instruct the steering device 130 and/or flow interceptor 235 to terminate delivery of the notified flow content.

### Example System Components

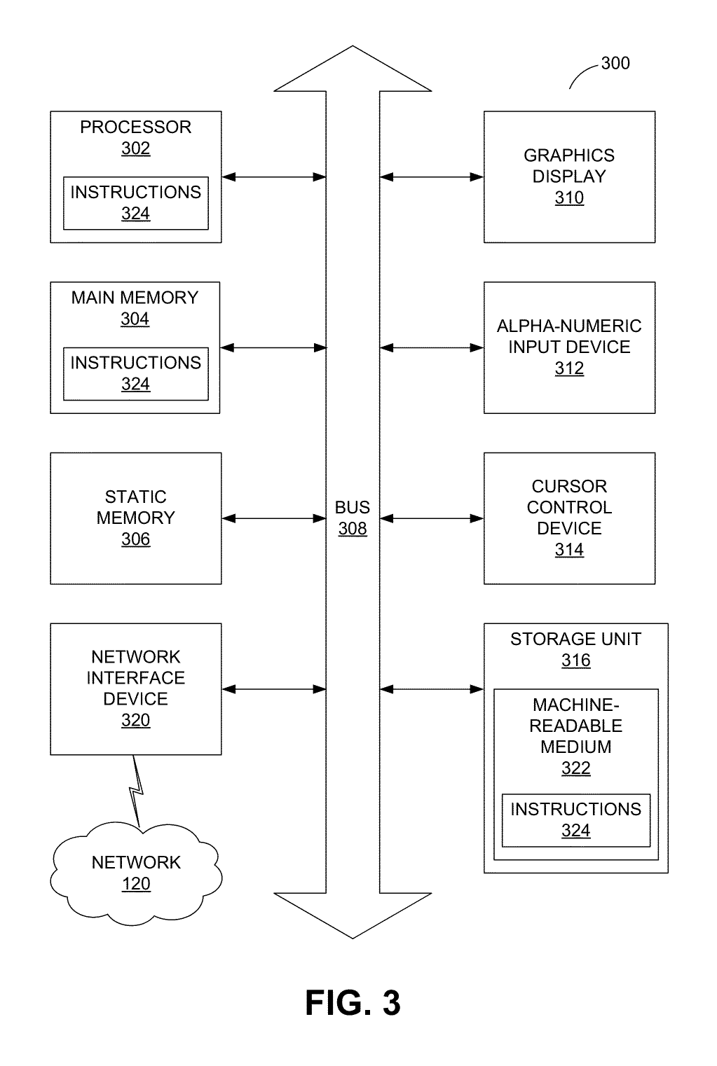

FIG. 3 is a block diagram illustrating components of an example machine able to read instructions from a machine-readable medium and execute them in a processor (or controller) to implement embodiments of the disclosed system for notifying a user about their data consumption on a network, according to one embodiment. For example, user devices 110, the steering device 130, network controller 240, and origin server 160 may include one or more of the components illustrated in FIG. 3. Specifically, FIG. 3 shows a diagrammatic representation of a machine in the example form of a computer system 300 within which instructions 324 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smart phone, a web appliance, a network router, switch or bridge, or any machine capable of executing instructions 324 (sequential or otherwise) that specify actions to be taken by that machine. Further, while only a single machine is illustrated, the term “machine” shall also be taken to include any collection of machines that individually or jointly execute instructions 324 to perform any one or more of the methodologies discussed herein.

The example computer system 300 includes one or more processors 302 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 304, and a static memory 306, which are configured to communicate with each other via a bus 308. The computer system 300 may further include graphics display unit 310 (e.g., a plasma display panel (PDP), a liquid crystal display (LCD), a projector, or a cathode ray tube (CRT)). The computer system 300 may also include alphanumeric input device 312 (e.g., a keyboard), a cursor control device 314 (e.g., a mouse, a trackball, a joystick, a motion sensor, or other pointing instrument), a storage unit 316, and a network interface device 320, which also are configured to communicate via the bus 308.

The storage unit 316 includes a machine-readable medium 322 on which is stored instructions 324 (e.g., software) embodying any one or more of the methodologies or functions described herein. The instructions 324 (e.g., software) may also reside, completely or at least partially, within the main memory 304 or within the processor 302 (e.g., within a processor's cache memory) during execution thereof by the computer system 300, the main memory 304 and the processor 302 also constituting machine-readable media. The instructions 324 (e.g., software) may be transmitted or received over a network 120 via the network interface device 320.

While machine-readable medium 322 is shown in an example embodiment to be a single medium, the term “machine-readable medium” should be taken to include a single medium or multiple media (e.g., a centralized or distributed database, or associated caches and servers) able to store instructions (e.g., instructions 324). The term “machine-readable medium” shall also be taken to include any medium that is capable of storing instructions (e.g., instructions 324) for execution by the machine and that cause the machine to perform any one or more of the methodologies disclosed herein. The term “machine-readable medium” includes, but not be limited to, data repositories in the form of solid-state memories, optical media, and magnetic media.

### Example Flow Analyzer

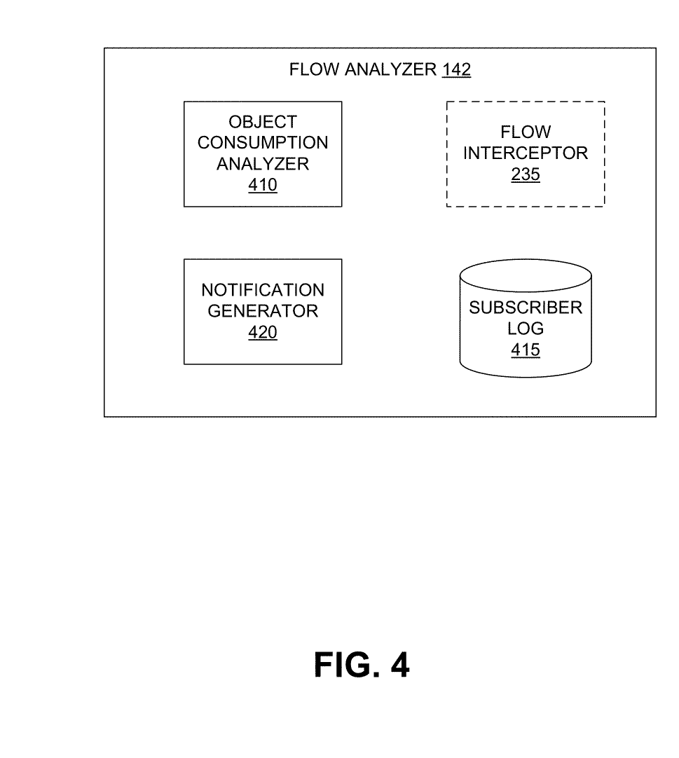

FIG. 4 illustrates a block diagram of a flow analyzer 142 for notifying a user about their data consumption on a network, according to one embodiment. As shown, the flow analyzer 142 includes an object consumption analyzer 410, subscriber log 415, and notification generator 420. Embodiments of the flow analyzer 142 may additionally include functionality of the flow interceptor 235, such as in the example environments 100A, 100B, and 200B in FIGS. 1A, 1B and FIG. 2B (although not shown), respectively, where the operations of the flow analyzer 142 and flow interceptor 235 are localized to a single computing device. In other embodiments, such as in the example environment 200A illustrated in FIG. 2A, the flow analyzer 142 and flow interceptor 235 may exist on separate computing devices.

As described above, the flow analyzer 142 analyzes a given flow to determine whether the flow would adversely impact the user of a user device. For example, the flow may be for a large object that would consume an inordinate amount of the user and/or user device's data allowance, cause the user and/or user device to exceed (or approach exceeding) the data allowance, or otherwise necessitate a user notification. If the flow would adversely impact the user of the user device or is otherwise determined to not be delivered to the user device, the flow analyzer 142 generates a notification for display on the user device to alert the user prior to delivery of the object or why the flow will not be continued. In the former case, the user may choose to continue a flow to receive the object and thereby incur data consumption associated with providing the object to their user device or choose not to continue a flow so as not incur data consumption associated with providing the object to their user device.

The object consumption analyzer 410 analyzes the network traffic associated with a flow to determine data parameters associated with the flow and objects therein. The network traffic associated with the flow may include requests and responses for content over protocols such as HTTP and TCP/IP packets containing content data. Based on the data parameters, the object consumption analyzer 410 determines a size of the flow, e.g., the amount of data that would be delivered to the user device. For example, the object consumption analyzer 410 may determine data parameters such as bit rate, resolution, and length for video/audio/image media data, packet payload and number of packets to receive, and other information that may be deduced from headers (e.g., HTTP, TCP/IP, etc) and payload information for an object (or objects) associated with the flow to determine the amount of data that would be delivered to the user device. The object consumption analyzer 410 may make the size determination for the flow as a whole and/or for individual objects therein. Once the object consumption analyzer 410 determines the amount of data that would be delivered to the user device from the flow and/or objects therein, the consumption analyzer 410 determines whether delivery of the amount of data would adversely affect the user. In one embodiment, the consumption analyzer 410 consults the information stored in a subscriber log 415 to determine whether the amount of data to be delivered in a flow would adversely affect the user of the user device.

The subscriber log 415 may contain network traffic data, subscriber account information, and/or other determined information for the user and/or user's devices. Example historical network traffic data may include information about flows associated with the user and/or user device such as tracked period data consumption (e.g., over a current billing cycle, week, or day). Example subscriber account information may include consumption properties describing allowed period data consumption (e.g., over a billing cycle, week, or day) and/or limits (or privileges) thereof, and/or data consumption limits (or privileges) for receiving a large object for one or more individual the user devices and/or for the subscriber account overall. Additional determined information stored in the subscriber log 415 may include consumption properties determined by the consumption analyzer 410 for the user and/or user's devices such as a threshold (e.g., 80% or 90%) of a consumption property for notifying the user of flows for large objects during a period when the user approaches exceeding the consumption property. Other consumption properties may include an amount of data remaining (e.g., over a billing cycle, week, or day) until reaching a limit or determined notification threshold for the user and/or user's devices.

In some embodiments, the subscriber log 415 may automatically retrieve or receive for storage the subscriber account information from a carrier or service provider providing network access to the user or user device. In other embodiments, the user may provide the subscriber account information directly or provide login credential for their subscriber account such that the subscriber log 415 may access subscriber account information from the corresponding carrier or service provider.

The consumption analyzer 410 may query the subscriber 415 with known user and/or user device information, such as an internet protocol address associated with the device, subscriber account ID, device ID number (e.g., International Mobile Equipment Identity (IMEI) number), mobile country code/mobile network code (MCC/MNC), etc., to receive the historic network traffic data, subscriber account information, and/or other determined information specific to the user and/or user device. Thus, for example, from the historical data usage and the amount of data to be delivered in a flow, the consumption analyzer 410 can determine whether the flow would exceed a consumption property such as allowed period data consumption (e.g., over a billing cycle, week, or day). In another example, from the amount of data to be delivered in a flow, the consumption analyzer 410 can determine whether the flow would exceed a consumption property such as an amount of data remaining (e.g., over a billing cycle, week, or day) until reaching a limit or determined notification threshold for the user and/or user device. Should the size of the flow and/or one or more objects therein cause the user and/or user device to exceed a consumption property, the object consumption analyzer 410 determines that a notification should be generated for display on the user device. Alternatively, if the size of the flow and/or one or more objects therein does cause the user and/or user device to exceed a consumption property, the object consumption analyzer 410 determines that no notification should be generated.

If the consumption analyzer 410 determines a notification should not be generated, the consumption analyzer 410 performs operations to continue to flow to the user device. The operations performed by the consumption analyzer 410 may differ depending on the embodiment.

In some embodiments, the consumption analyzer 410 categorizes the flow to continue the flow of traffic between the user device and the network. For example, as illustrated in FIG. 1B, where the flow analyzer 142 is implemented on the user device, the consumption analyzer 410 categorizes the flow such the user device (and application thereon) may receive and/or transmit additional traffic associated with the flow. In one embodiment, the consumption analyzer 410 may perform operations to enable receipt or transmission of additional traffic associated with the flow, for example, by keeping a flow alive (not allowing timeout), confirming receipt of a packet, generating or transmitting a request for data, etc.

In some embodiments, the consumption analyzer 410 categorizes the flow to continue the flow such that steering logic on the steering device 130 transmits network traffic associated with the flow to the user device and/or origin server. For example, as illustrated in FIG. 1A, where the flow analyzer 142 is implemented in-line.

In some embodiments, the consumption analyzer 410 provides received network traffic associated with the flow to the steering device 130. Further, the consumption analyzer 410 may provide a category for the flow to the flow interceptor 235 and/or steering device 130 such that additional traffic associated with the flow is not passed to the flow analyzer 142 for analysis. For example, as illustrated in FIGS. 2A and 2B, where the flow analyzer 142 is implemented out-of-band.

In some embodiments, the consumption analyzer 410 determines whether a notification should be generated for only certain portions of a flow, such as one or more large objects therein. In such cases, the consumption analyzer 410 may provide received network traffic associated with other flow content to the steering device 130 for routing to the user device 110. In some embodiments, the consumption analyzer 410 may not provide a category for the flow to the flow interceptor 235 and/or steering device 130 such that additional traffic associated with the flow is still passed to the flow analyzer 142. Traffic not associated with the portions of the flow for which the notification is generated is identified and provided back to the steering device 130. In other embodiments, the consumption analyzer 410 may provide one category for the portions of the flow to the flow interceptor 235 and/or steering device 130 that should be routed to the flow analyzer 142, and another category for other portions the flow that should be continued. Thus, the flow analyzer 142 only receives additional traffic for the portions of the flow for which the user was notified. In either instance, the user may receive some flow content (e.g., small objects) but be notified of other flow content (e.g., large objects).

If the consumption analyzer 410 determines that a notification should be generated for a flow and/or one or more objects therein, the consumption analyzer 410 passes information about the flow content for which the user should be notified of to the notification generator 420. Additionally, the consumption analyzer 410 may pass information about the consumption properties the flow content exceeds and a current status of data consumption to the notification generator 420.

The notification generator 420 generates notifications including notification information for display on the user device. For example, the notification generator 420 may transmit the notification to the user device (which may be routed through the steering device). In some embodiments, a notification includes the notification information. In other embodiments, the notification directs the user device to retrieve the notification information.

The notification generator 420 determines the notification information from the flow content for which the user should be notified of, the consumption properties the flow content exceeds, and/or a current status of data consumption. The notification generator 420 may present the notification information in a format easily understood by the user. Example notification information can include: information about the flow overall such as size, number of objects, type of objects, etc., information about a large object such as size, length, bitrate, etc., warning that data usage for the flow or object would exceed a given data limit or notification threshold, an amount (or percentage) by which the flow or object would exceed the data limit or notification threshold, an amount (or percentage) of data limit remaining prior to and/or after continuing the flow or object, etc. Other example notification information may include information about why a flow or object will not be delivered to the user device. For example, in instances where the flow content exceeds a consumption property such as a parental limit, overall object size limit, or the user's account is not in good standing.

In some embodiments, the notification generator 420 may additionally include response options in the notification information for the user to respond to the notification. Example response options may include do not play (do not continue), play (continue), and/or other options such as quality. The do not play (do not continue) option may, for a large object, prevent delivery of data associated with the large object. The do not play (do not continue) option may, for a large flow, prevent delivery of data associated with the flow and/or include a return to previously viewed content (e.g., back). The play (continue) option may cause the user device to receive flow content. A quality option (e.g., provided by the notification generator 420 based on type of flow content) may enable the user to receive transcoding or optimization services for flow content such as video/image/audio. Other options may include on-device operations such as exiting the application requesting the flow content, blocking the source of flow content and/or requesting application, etc. Thus, the user may indicate their preference for receiving (or not receiving the content), adjust a quality associated with the content via the notification, and/or take action on their device. The user may also respond to the notification in other ways. For example, the user may rerequest the same content within a given timeframe, thereby indicating they would like to receive the content. In another example, if the user does not rerequest the same content within the given timeframe, or requests other content instead, the user thereby indicates they would not like to receive the content.

In some embodiments, the notification generator 420 monitors received traffic associated with flow content to which a user was notified for a response to the notification. In other embodiments, the notification generator 420 may receive the response directly on the user device. As described above, the response may indicate whether the user wants to receive notified flow content or not receive notified flow content. If the user indicates in a notification response they would like to receive notified flow content, the notification generator 420 performs operations, such as those described above with reference to embodiments of the consumption analyzer 410, to continue notified flow content to the user device.

In some embodiments, the notification response received at the notification generator 420 may indicate the user desires to receive transcoding or optimization services for the notified flow content. In such cases, the notification generator 420 may transmit an optimizer redirect to the user device specifying a location (e.g., an optimizer) where the user device can receive optimized flow content. In one embodiment, the notification generator 420 transmit information about the notified flow content or forwards the notified flow content to the optimizer, which performs retrieval of data for the notified flow content, optimizes the flow content, and provides the optimized flow content to the user device. In some embodiments, the optimizer redirect causes the user device to request the notified flow content from the optimizer automatically such as by including information about the notified flow content (e.g., location on the network) in the redirect.

If the user indicates in a notification response they do not want to receive flow content, the notification generator 420 performs operations to prevent delivery of notified flow content to the user device. For example, the notification generator 420 may instruct the steering device 130 and/or flow interceptor 235 to terminate delivery of the notified flow content. In turn, the steering device 130 and/or flow interceptor 235, for example, may prevent transmission of a request for the content received from the user device to an origin server, or prevent transmission of a response and/or content data received from the origin server to the user device.

### Example Flow Analyzer

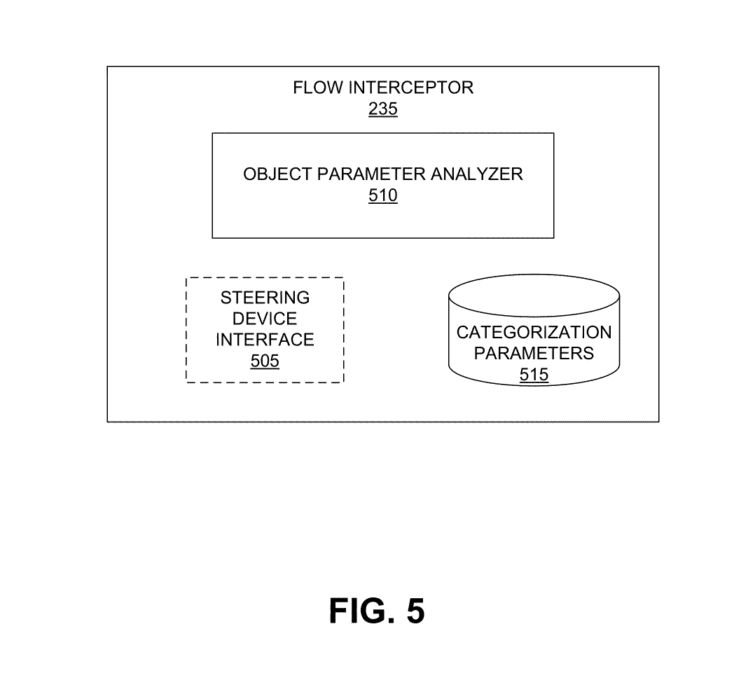

FIG. 5 illustrates a block diagram of a flow interceptor 235 for selecting flows to analyze for notifying a user about their data consumption on a network, according to one embodiment. As shown, the flow interceptor 235 includes an object parameter analyzer 510 and categorization parameters 515. Embodiments of the flow interceptor 235 may additionally include a steering device interface 505 where the operations of the flow interceptor 235 off-loaded from an in-line appliance such as steering device 130.

The flow interceptor 235 categorizes flows based on flow parameters associated with the flow to intercept network traffic for flows identified for further inspection at the flow analyzer 142. Exampling flow parameters may include the type of objects in the flow, number of each type, associated packet or object sizes, duration of the flow (e.g., long or short), expected number of packets, etc. In embodiments where the flow interceptor 235 is implemented on a steering device 130 and/or user device 110, the flow interceptor 235 may access flow parameters directly. In other embodiments, where the operations of the flow interceptor 235 in networked implementations are off-loaded from the steering device 130, the flow interceptor 235 may utilize a steering device interface 505 to receive or otherwise obtain parameters for flows through the steering device 130. For example, the flow interceptor 235 may utilize the steering device interface 505 to access flow parameters on the steering device 130. In another example, the steering device 130 may query the flow interceptor 235 via the interface 505 with flow parameters.

The object parameter analyzer 510 compares flow parameters with categorization parameters 515 to determine a category for the flow and/or objects therein. Categorization parameters 515 may be based on the object types, limits on number of objects (total or for a type), object/packet size limits, flow duration limits (e.g., long lived flows often have large packet sizes), number of packets to receive limits, etc. that indicate whether the flow contains a sufficiently small amount of data or could contain a large amount of data in an individual object and/or as a whole. If object parameter analyzer 510 determines parameters for the flow and/or object(s) therein exceeds one or more of the categorization parameters, the object parameter analyzer 510 categorizes the flow and/or one or more objects therein for inspection at the flow analyzer 142.

In some embodiments, the object parameter analyzer 510 stores the category at the steering device 130 and/or locally (e.g., in embodiments where the flow analyzer 142 is implemented at the user device) such that the flow analyzer 142 further analyzes the flow. In some embodiments, the object parameter analyzer 510 stores the category at the steering device 130 such that steering logic routes the network traffic associated with the flow to the flow analyzer 142. In some embodiments, the object parameter analyzer 510 provides the category to the steering device 130 such that steering logic routes the network traffic associated with the flow to the flow analyzer 142. In some embodiments, the object parameter analyzer 510 modifies steering logic at the steering device via the interface 505 based on the determined category such that steering logic routes the network traffic associated with the flow to the flow analyzer 142. In some embodiments, the object parameter analyzer 510 stores the category, identifies traffic associated with the flow and/or object, and selectively instructs the steering device 130 to route the network traffic associated with the flow to the flow analyzer 142. For example, the object parameter analyzer 510 may identify the traffic associated with the flow and selectively transmit routing instructions via the interface 505.

If object parameter analyzer 510 determines parameters for the flow and/or object(s) therein do not exceeds one or more of the categorization parameters, the object parameter analyzer 510 categorizes the flow and/or one or more objects therein such that they are continued to the user device. In some embodiments, the object parameter analyzer 510 stores the category at the steering device 130 such that the flow analyzer 142 does not further analyze the flow. In some embodiments, the object parameter analyzer 510 stores the category at the steering device 130 such that steering logic routes the network traffic associated with the flow between the user device and the origin server. In some embodiments, the object parameter analyzer 510 provides the category to the steering device 130 such that steering logic routes the network traffic associated with the flow between the user device and the origin server. In some embodiments, the object parameter analyzer 510 modifies steering logic at the steering device via the interface 505 based on the determined category such that steering logic routes the network traffic associated with the flow between the user device and the origin server. In some embodiments, the object parameter analyzer 510 stores the category and ignores the traffic associated with the flow and/or object such that the steering device 130 routes the network traffic associated with the flow between the user device and the origin server.

Additionally, the object parameter analyzer 510 may receive a category from the flow analyzer 142 for a flow and/or one or more objects therein previously selected for further inspection indicating continuance to the user device. Accordingly, the object parameter analyzer 510 may modify the category of the flow and/or one or more objects therein such that they are continued to the user device as described above.

In embodiments where the flow analyzer 142 is implemented at the user device, the flow interceptor 235 may perform one or more of the above operations of the steering device 130 locally and/or include an interface (not shown) with functionality similar to the steering device interface to communicate with elements (e.g., to inspect, categorize, and provide instructions for network traffic of flows) on the user device that handle network traffic on the user device such as network interface device 320.

### Example Pro-Active Alerts

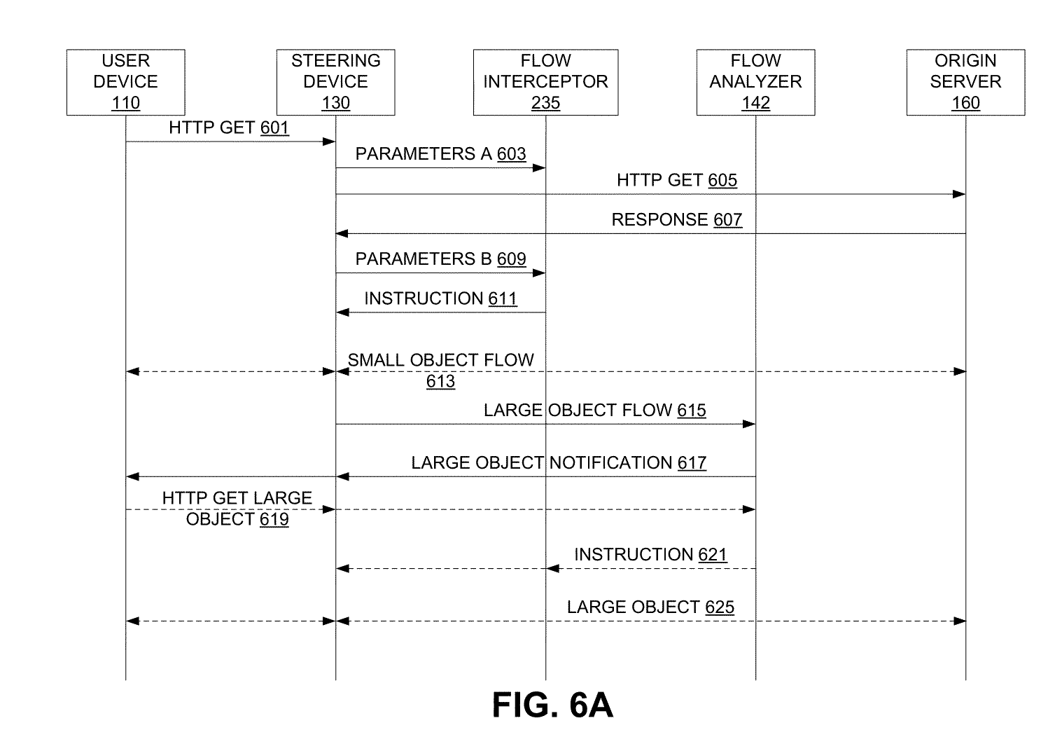

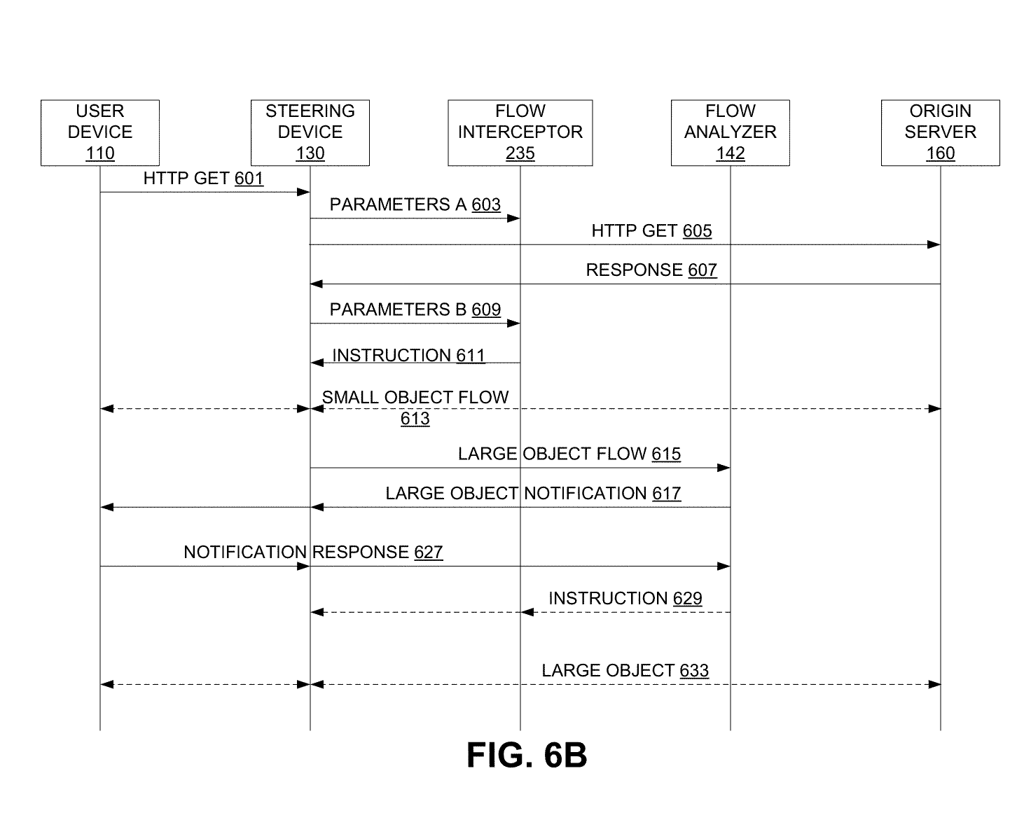

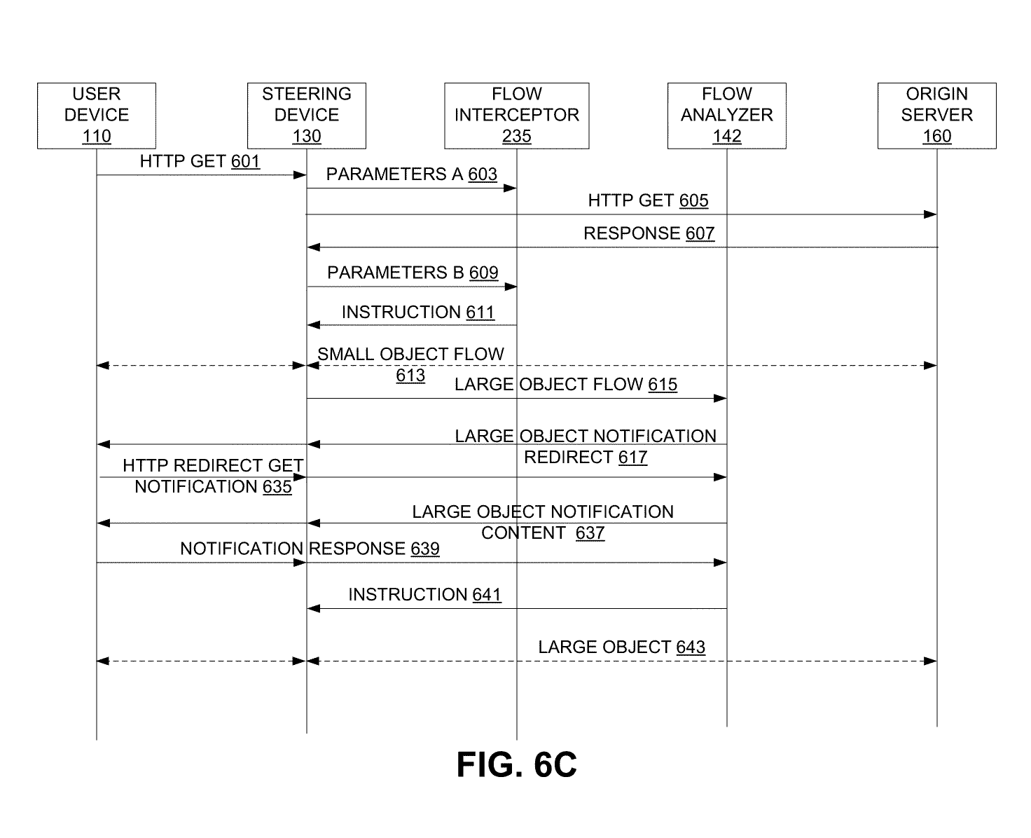

FIGS. 6A, 6B, and 6C illustrate example event traces for notifying a user about their data consumption on a network, according to various embodiments. For example, the user may consume content such as videos, text, images, etc. and retrieve other data on the network.

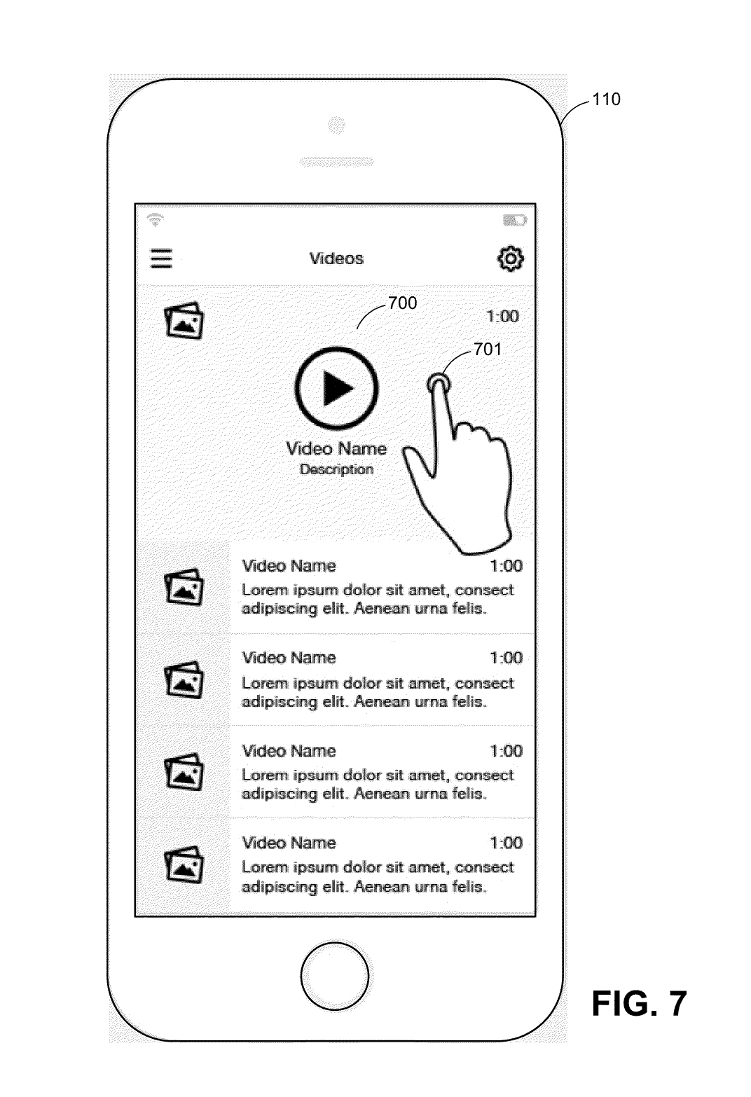

Referring briefly to FIG. 7, FIG. 7 illustrates an example user interaction associated with consuming data on a network, according to one embodiment. As shown, a user device displays an interface including a video object 700 that may be selected 701 by the user for playback on the user device. Selection 701 of the video object may cause the user device to initiate a request for the video content. In other instances, the video content may be requested automatically, such as upon opening a webpage containing video content that plays automatically.

Turning back to FIGS. 6A-C, the user device 110 initiates a flow including one or more requests 601 for content on an origin server 160 such as with an HTTP get 601 request (e.g., for an object, webpage, or other online content) which is received by the steering device 130. The steering device 130 receives the get request 601 and passes the HTTP get request 605 to the origin server 160. The origin server 160 generates a response 607 to the get request, the response 607 may contain data for or about the object, webpage, or other online content.

The flow interceptor 235 may inspect flow parameters A 603 associated with the get request 601 and/or inspect flow parameters B 609 associated with the response 607. In the illustrated examples, the flow interceptor 235 inspects parameters associated with a flow for providing an object from the origin server 160 to the user device 110 for clarity. Delivery of the object to the user device may consume an amount of data on a network that would be detrimental to the user.

Similar processes may be performed to categorize flows containing many objects in the aggregate, for example, the response 607 may indicate a webpage containing many small objects rather as opposed to one or several large ones.

As shown, the flow interceptor 235 inspects the flow parameters associated with providing the object from the origin server 160 to the user device 110. Based on the flow parameters, the flow interceptor 235 determines a category for the flow, e.g., large or small. For example, the flow interceptor 235 may determine a category based on object type, such as small (e.g., text) object or large (e.g., video) object. In another example where the flow parameters indicate many objects, the flow interceptor 235 may determine a category based on object type and quantity, such as small (e.g., few image objects) or large in the aggregate (e.g., tens or hundreds of image objects).

The flow interceptor 235 instructs 611 the steering device 130 based on the category determined for the flow. For example, instructions 611 for a flow categorized as containing a large object cause the steering device 130 to route traffic associated with the large object flow 615 through the flow analyzer 142 (or the flow analyzer 142 to otherwise inspect the traffic associated with the flow). Alternatively, instructions for a flow categorized as containing a small object cause the steering device 130 to continue traffic associated with the small object flow 613 between the origin servicer 160 and the user device 110.

The flow analyzer 142 inspects the large object flow 615 to determine whether to generate a notification. The flow analyzer 142 determines a size of the object to be delivered, and determines whether delivery of the object would exceed consumption parameters for the user and/or user device 110. If delivery of the object would exceed consumption parameters for the user and/or user device 110, the flow analyzer 142 generates a notification for display on the user device 110. The notification may include notification information describing the object and the consumption parameters the user would exceed by consuming the object.

Although not shown, if no notification should be generated, the flow analyzer 142 may provide a category for the flow (e.g., small) to the flow interceptor 235 and/or steering device 130 to continue the large object flow (e.g., as illustrated for small object flow 613).

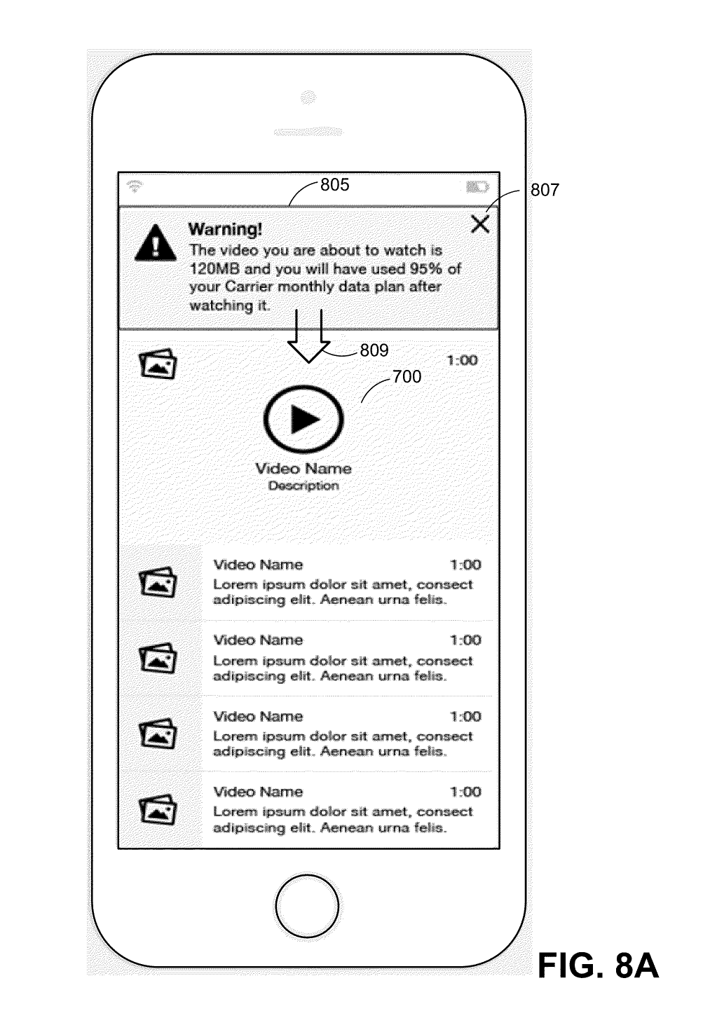

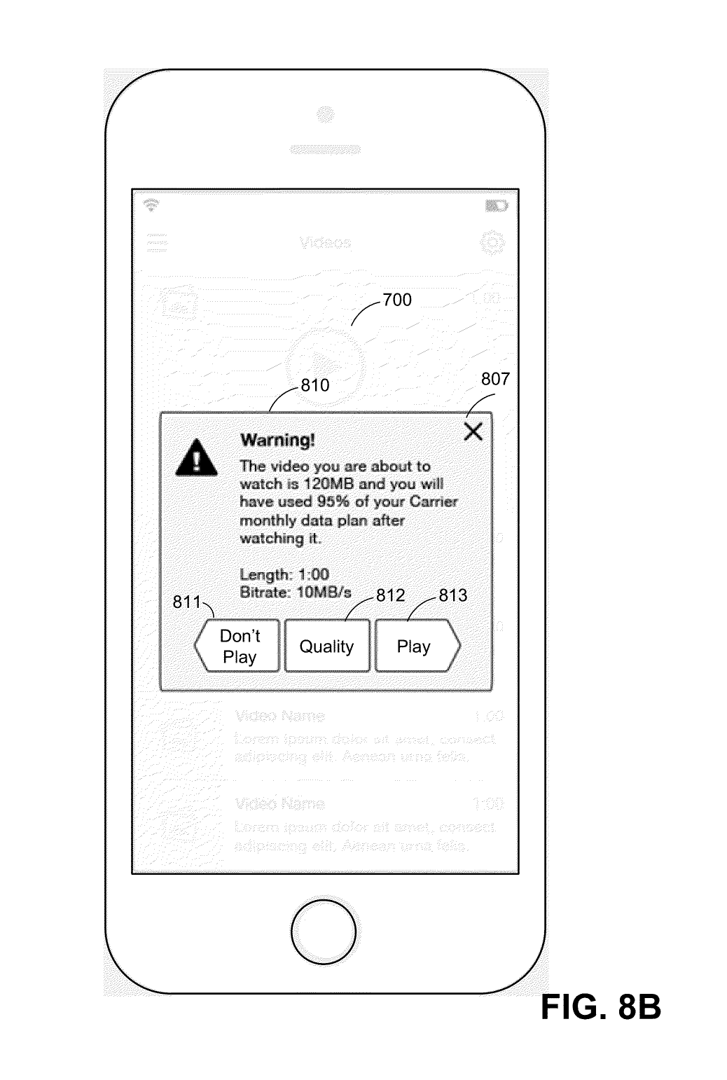

Referring specifically now to FIG. 6A, which illustrates an event trace for generating a banner notification for a large object, such as the banner notification illustrated in FIG. 8A, the flow analyzer 142 transmits the large object notification 617 for display on the user device 110.

FIG. 8A illustrates an example user interfaces on a user device for notifying a user about their data consumption on a network, according to one embodiment. For example, a banner notification 805 may be displayed at a top or bottom or other location of the user interface of the user device. The notification may slide 809 into position within the interface to display notification information. For example, the notification information in response to a selection to playback video object 700 may include information about the video and the consumption property, such as “the video you are about to watch is 120 MB and you will have used 95% of your carrier monthly data plan after watching it.” The use may elect to close 807 the notification or, alternatively, select an area outside the notification to close those notification. In one embodiment, the notification slides back 809 from view to again display the interface in FIG. 7. The user may elect to watch the video by rerequesting the video content, e.g., by subsequent selection 701.

Turning back to FIG. 6A, if the user elects to watch the video by rerequesting the video content, the user device 110 attempts a second HTTP get 619 for the large object. The flow analyzer 142 receives the rerequest as associated with the large object to which the user was notified, and thus, identifies that the user desires to continue the flow to receive the large object. Accordingly, the flow analyzer 142 provides instructions 621 to the flow interceptor 235 and/or steering device 130 to continue the large object flow 625. In some embodiments, the flow analyzer 142 hands the response 607 for the video content (large object flow 615) back to the steering device 130 with the instruction 621. The steering device 130, in turn, passes the response 607 to the user device 110 along with routing additional large object flow traffic 625 between the origin server 160 and the user device 110. Additionally, the flow analyzer 142 may provide a category for the flow (e.g., small) in the instructions 621 to the flow interceptor 235 and/or steering device 130 to continue the large object flow 625 without further intrusion. If the user does not rerequest the video content within a given timeframe, the flow analyzer 142 may instruct the flow interceptor 235 and/or steering device 130 to terminate the flow.

Referring specifically now to FIG. 6B, which illustrates an event trace for generating an overlay notification for a large object, such as the overlay notification illustrated in FIG. 8B, the flow analyzer 142 transmits the large object notification 617 for display on the user device 110.

FIG. 8A illustrates an example user interfaces on a user device for notifying a user about their data consumption on a network, according to one embodiment. For example, an overlay notification 810 may be displayed overlaying the video object 700 on the user device 110. The overlay notification 810 and information therein may be displayed with different contrast than the overlaid content in the background, such as by dimming the background content in comparison to the notification information. The notification information displayed in response to a selection to playback video object 700 may include information about the video and the consumption property, such as “the video you are about to watch is 120 MB and you will have used 95% of your carrier monthly data plan after watching it.” The use may elect to close 807 the notification or, alternatively, select from options 811, 821, 813 provided within the notification. Example response options for a video object 700 may include do not play 811, play 813, and quality 812. The quality option 812 may enable the user to receive transcoding or optimization services for the video object. The user may elect to play the video via the play option 813. The user may elect to not play the video via the do not play option 811.

Turning back to FIG. 6B, if the user elects to watch the video by selecting the play option 811, the flow analyzer receives a notification response 627 indicating the user's preference and instructs 629 the flow interceptor 235 and/or steering device 130 to continue the large object flow 633. In some embodiments, the flow analyzer 142 hands the response 607 for the video content (large object flow 615) back to the steering device 130 with the instruction 629. The steering device 130, in turn, passes the response 607 to the user device 110 along with routing additional large object flow traffic 633 between the origin server 160 and the user device 110. Additionally, the flow analyzer 142 may provide a category for the flow (e.g., small) in the instructions 629 to the flow interceptor 235 and/or steering device 130 to continue the large object flow 633 without further intrusion.

If the user elects to watch the video but selects from a quality option 812 to optimize the video, the flow analyzer receives a notification response 627 indicating the user's preference and instructs 629 the flow interceptor 235 and/or steering device 130 to route the flow through an optimizer (not shown). For example, the instruction may include redirect request transmitted to the user device 110 directing the user device to the optimizer. The flow analyzer 142 may include information about the content the user device desires to receive from the optimizer in the redirect, or optionally transmit the information about the content itself to the optimizer. In either instance, the user device 110 requests the content from the optimizer, which retrieves the content from the origin server for optimization prior to delivery to the user device 110. Additionally, the flow analyzer 142 may provide a category for the optimized flow (e.g., small) in the instructions 629 to the flow interceptor 235 and/or steering device 130 such that the optimized flow is continue without further intrusion.

If the user elects to not watch the video by selecting the do not play option 813 or does not respond to the notification within a given timeframe (e.g., by closing the notification), the flow analyzer 142 may instruct the flow interceptor 235 and/or steering device 130 to terminate the flow.

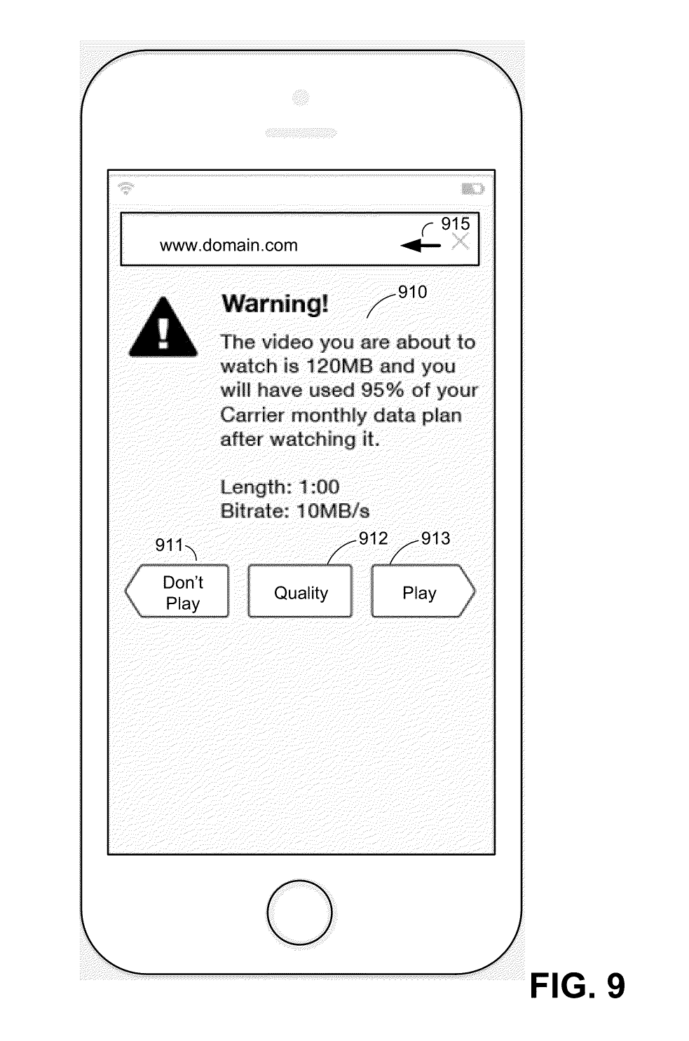

Referring specifically now to FIG. 6C, which illustrates an event trace for generating a redirect notification for a large object, such as the redirect notification illustrated in FIG. 9, the flow analyzer 142 transmits the large object notification 617 redirect to the user device 110. The large object notification 617 redirects the user to a location (e.g., webpage) displaying the notification. Accordingly, the user device 110 may generate a get request 635 for the notification to receive the large object notification content 637. In other embodiments, the large object notification redirect 617 may include the large object notification content 637, e.g., by providing the user device 110 the large object notification content 637 of the webpage to display. In this simplified example, the user device 110 need not perform the get notification 635 request.

FIG. 9 illustrates an example web page displayed on a user device for notifying a user about their data consumption on a network, according to one embodiment. For example, webpage notification 910 may be displayed within a new webpage on the user device 110. In other embodiments, the notification may not direct the user device 110 to a new webpage but replace the one or more objects (e.g., video 700 in FIG. 7) the user is being notified of with notification content in an existing one. The notification information displayed in response to a selection to playback a video object (e.g., video object 700 in FIG. 7) may include information about the video and the consumption property, such as “the video you are about to watch is 120 MB and you will have used 95% of your carrier monthly data plan after watching it.” The use may elect to go back 915 from the notification or, alternatively, select from options 911, 921, 913 provided within the notification. Example response options for a video object 700 may include do not play 911, play 913, and quality 912. The quality option 912 may enable the user to receive transcoding or optimization services for the video object. The user may elect to play the video via the play option 913. The user may elect to not play the video via the do not play option 911.

Turning back to FIG. 6C, if the user elects to watch the video by selecting the play option 911, the flow analyzer receives a notification response 639 indicating the user's preference and instructs 641 the flow interceptor 235 and/or steering device 130 to continue the large object flow 643. In some embodiments, the flow analyzer 142 hands the response 607 for the video content (large object flow 615) back to the steering device 130 with the instruction 641. The steering device 130, in turn, passes the response 607 to the user device 110 along with routing additional large object flow traffic 643 between the origin server 160 and the user device 110. Additionally, the flow analyzer 142 may provide a category for the flow (e.g., small) in the instructions 641 to the flow interceptor 235 and/or steering device 130 to continue the large object flow 643 without further intrusion.

If the user elects to watch the video but selects from a quality option 912 to optimize the video, the flow analyzer receives a notification response 639 indicating the user's preference and instructs 641 the flow interceptor 235 and/or steering device 130 to route the flow through an optimizer (not shown). For example, the instruction may include redirect request transmitted to the user device 110 directing the user device to the optimizer. The flow analyzer 142 may include information about the content the user device desires to receive from the optimizer in the redirect, or optionally transmit the information about the content itself to the optimizer. In either instance, the user device 110 requests the content from the optimizer, which retrieves the content from the origin server for optimization prior to delivery to the user device 110. Additionally, the flow analyzer 142 may provide a category for the optimized flow (e.g., small) in the instructions 641 to the flow interceptor 235 and/or steering device 130 such that the optimized flow is continue without further intrusion.

If the user elects to not watch the video by selecting the do not play option 913 or does not respond to the notification within a given timeframe (e.g., by going back from the notification), the flow analyzer 142 may instruct the flow interceptor 235 and/or steering device 130 to terminate the flow.

### Additional Configuration Considerations

Through use of a system, method, and computer readable storage medium storing computer program instructions for pro-actively notifying a user about their data consumption on a network for a flow, users can make informed decisions about whether to continue the flow and thereby incur data usage and any associated costs. While a user may utilize a flow analyzer at their device to prevent detrimental data consumption as it pertains to their individual, network based implementations are also discussed. Thus, a service provider may implement embodiments described herein to enhance user experience for the multitudes of users subscribed to their service. In either instance, a user is notified of flows that may involve detrimental data consumption and may also be provided with options for choosing whether to continue the flow in light of the notification. Accordingly, users can remain aware of their data consumption habits and provided options for controlling data consumption prior to incurring significant data usage that adversely affects them.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms such as a flow analyzer, flow interceptor, steering logic, etc. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors 302) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods (e.g., as described with FIGS. 6A-C) described herein may be performed, at least partially, by one or more processors (e.g., processor 302) that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Some portions of this specification are presented in terms of algorithms or symbolic representations of operations on data stored as bits or binary digital signals within a machine memory (e.g., a computer memory 304). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system, method, and computer readable storage medium storing computer program instructions for notifying a user about their data consumption on a network through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for selectively transmitting to a user device a notification of data consumption on a network, the method comprising:
receiving flow information about a data flow between an origin server and the user device, the data flow for delivering content from the origin server to the user device in response to a request for the content from the user device;
determining a category for the data flow based on the flow information, a first category identifying the data flow to continue delivery of the content from the origin server to the user device and a second category identifying the data flow for further inspection prior to continuing delivery of the content from the origin server to the user device;
determining, responsive to categorizing the data flow in the second category, a data size associated with the data flow based on the content for delivery from the origin server to the user device;
determining whether the data size associated with the data flow exceeds a consumption property associated with the user device; and
generating, responsive to determining the data size associated with the data flow exceeds a consumption property, a notification for display on the user device to the user of the data flow exceeding the consumption property prior to continuing delivery of the content from the origin server to the user device.

2. The method of claim 1, wherein the first category comprises flows for delivering content of minimal data size from the origin server to the user device.

3. The method of claim 2, wherein content of minimal data size comprises one or more of text, images, and audio objects.

4. The method of claim 1, wherein the second category comprises flows for delivering content of large data size from the origin server to the user device.

5. The method of claim 4, wherein content of large data size comprises video objects.

6. The method of claim 1, wherein the second category comprises flows for delivering content having a large data size in aggregate from the origin server to the user device.

7. The method of claim 6, wherein content having a large data size in aggregate comprises many of one or more of video, image, and audio objects.

8. The method of claim 1, wherein the flow information comprises parameters describing one or more of a type of objects in the data flow, number of each type of objects, size of the objects, packet size for the data flow, duration of the flow, and number of packets in the data flow.

9. The method of claim 1, wherein consumption properties associated with the user device comprise one or more of allowed period data consumption, data consumption limits for an individual data flow, a notification threshold for allowed period data consumption.

10. The method of claim 1, wherein the notification comprises an option to continue delivery of the content from the origin server to the user device.

11. The method of claim 1, further comprising:
responsive to a notification response indicating the user desires to continue delivery of the content from the origin server to the user device, continuing delivery of the content from the origin server to the user device.

12. The method of claim 11, wherein continuing delivery of the content from the origin server to the user device comprises categorizing the data flow in the first category.

13. The method of claim 1, further comprising:
responsive to a notification response indicating the user desires to receive an optimized version of the content, redirecting the user device to an optimizer to continue delivery of the content from the origin server to the user device, where the optimizer receives the content from the origin server, optimizes the content, and provides the optimized version of the content to the user device.

14. A computer program product comprised of a non-transitory computer-readable storage medium storing executable computer program instructions to transmit to a user device a notification of data consumption on a network, the instructions when executed cause one or more processors to:
receive flow information about a data flow between an origin server and the user device, the data flow for delivering content from the origin server to the user device in response to a request for the content from the user device;
determine a category for the data flow based on the flow information, a first category identifying the data flow to continue delivery of the content from the origin server to the user device and a second category identifying the data flow for further inspection prior to continuing delivery of the content from the origin server to the user device;
determine, responsive to categorizing the data flow in the second category, a data size associated with the data flow based on the content for delivery from the origin server to the user device;
determine whether the data size associated with the data flow exceeds a consumption property associated with the user device; and
generate, responsive to determining the data size associated with the data flow exceeds a consumption property, a notification for display on the user device to alert the user of the data flow exceeding the consumption property prior to continuing delivery of the content from the origin server to the user device.

15. The computer program product of claim 14, wherein the flow information comprises parameters describing one or more of a type of objects in the data flow, number of each type of objects, size of the objects, packet size for the data flow, duration of the flow, and number of packets in the data flow.

16. The computer program product of claim 14, wherein consumption properties associated with the user device comprise one or more of allowed period data consumption, data consumption limits for an individual data flow, a notification threshold for allowed period data consumption.

17. The computer program product of claim 14, wherein the notification comprises an option to continue to continue delivery of the content from the origin server to the user device.

18. The computer program product of claim 14, further comprising instructions that when executed causes the one or more processors to:
continue, responsive to a notification response indicating the user desires to continue delivery of the content from the origin server to the user device, delivery of the content from the origin server to the user device.

19. The computer program product of claim 18, wherein the instruction to continue delivery of the content from the origin server to the user device further comprises instructions that when executed causes the one or more processors to categorize the data flow in the first category.

20. The computer program product of claim 14, further comprising instructions that when executed causes the one or more processors to:
redirect, responsive to a notification response indicating the user desires to receive an optimized version of the content, the user device to an optimizer to continue delivery of the content from the origin server to the user device, where the optimizer receives the content from the origin server, optimizes the content, and provides the optimized version of the content to the user device.

21. A system for transmitting notification of data consumption on a network, the system comprising:
a first processing device comprising a non-transitory computer-readable storage medium storing a flow interceptor module comprising executable computer program instructions and a processor for executing the flow interceptor module to:
receive flow information corresponding to data flows between origin servers and user devices on the network, each data flow for delivering associated content from one of the origin servers to one of the user devices; and
determine a category for each of the data flows based on the corresponding flow information, assigning at least a first data flow of the data flows to a first category identifying the first data flow to continue delivery of associated content and assigning at least a second of the data flows the a second category identifying the second data flow for further inspection prior to continuing delivery of associated content;
a second processing device comprising a non-transitory computer-readable storage medium storing a flow analyzer module comprising executable computer program instructions and a processor for executing the flow analyzer module to:
determine a data size associated with the second data flow based on the associated content for delivery from a target origin server of the origin servers to a target user device of the user devices;
determine whether the data size associated with the second data flow exceeds a consumption property associated with the target user device; and
responsive to determining the data size associated with the second data flow exceeds a consumption property, generate a notification for display on the target user device to alert a user of the target user device of the second data flow exceeding the consumption property prior to continuing delivery of the associated content from the target origin server to the target user device.

22. The system claim 21, wherein the first processing device and the second processing device are implemented as a single processing device.

23. The system claim 22, wherein the single processing device is an in-line steering appliance.

24. The system claim 22, wherein the single processing device is an out-of-band network controller coupled to an in-line steering appliance.

25. The system claim 21, wherein the first processing device is an in-line steering appliance and the second processing device is an out-of-band network controller coupled to the in-line steering appliance.

26. A computer-implemented method to transmit notification of data consumption on a network to a user device, the method comprising:
receiving flow information about a data flow between an origin server and the user device, the data flow for delivering one or more objects from the origin server to the user device;
determining a category for the data flow based on the flow information, a first category identifying the data flow to continue delivery of the one or more objects from the origin server to the user device and a second category identifying the data flow for further inspection prior to continuing delivery of the one or more objects from the origin server to the user device;
determining, responsive to categorizing the data flow in the second category, a data size for each of the one or more objects for delivery from the origin server to the user device;
determining whether the data size of one of the objects exceeds a consumption property associated with the user device; and
generating, responsive to determining the data size associated with the one of the objects exceeds a consumption property, a notification for display on the user device to alter the user of the one of the objects exceeding the consumption property prior to continuing delivery of the one of the objects from the origin server to the user device.

27. The method of claim 26, wherein the flow information comprises parameters describing one or more of a type of the one or more objects in the data flow, number of each type of the one or more objects, size of each of the one or more objects, packet size for the data flow, duration of the flow, and number of packets in the data flow.

28. The method of claim 26, wherein consumption properties associated with the user device comprise one or more of allowed period data consumption, data consumption limits for an individual data flow, a notification threshold for allowed period data consumption.

29. The method of claim 26, further comprising:
responsive to a notification response indicating the user desires to continue delivery of the one of the objects exceeding the consumption property from the origin server to the user device, continuing delivery of the one of the objects exceeding the consumption property from the origin server to the user device.

30. The method of claim 26, further comprising:
responsive to a notification response indicating the user desires to receive an optimized version of the one of the objects exceeding the consumption property, redirecting the user device to an optimizer to continue delivery of the one of the objects exceeding the consumption property from the origin server to the user device, where the optimizer receives the one of the objects exceeding the consumption property from the origin server, optimizes the one of the objects exceeding the consumption property, and provides the optimized version of the one of the objects exceeding the consumption property to the user device.
